(19) United States
(12) Patent Application Publication
(10) Pub. No.: US 2019/0346010 A1
(43) Pub. Date: Nov. 14, 2019

(54) METHOD FOR DETERMINING A STATE OF A TORSIONAL VIBRATION DAMPER OF A VEHICLE

(71) Applicant: Schaeffler Technologies AG & Co. KG, Herzogenaurach (DE)

(72) Inventor: Carsten Mohr, Bühlertal (DE)

(73) Assignee: Schaeffler Technologies AG & Co. KG, Herzogenaurach (DE)

(21) Appl. No.: 16/461,421

(22) PCT Filed: Nov. 14, 2017
(86) PCT No.: PCT/DE2017/100961

§ 371 Date: May 16, 2019

(30) Foreign Application Priority Data
Dec. 9, 2016 (DE) 10 2016 123 930.5

(51) Int. Cl. F16F 15/00; F16F 15/123

(52) U.S. Cl. CPC F16F 15/002; F16F 15/123; F16F 2230/24; F16F 2230/46; F16F 2230/0047; F02D 2200/025

(57) ABSTRACT

A failure state of a torsional vibration damper is analyzed by means of an acoustic sensor. The acoustic sensor may be present in the vehicle for other reasons, such as a knock sensor of a gasoline engine or an injection sensor of a diesel engine. Fault images of the torsional vibration damper are determined for specified operating points of the vehicle during vehicle operation. The fault monitoring can be carried out easily while the vehicle is being driven and replaces a visual check in the workshop.

### CROSS-REFERENCE TO RELATED APPLICATIONS

This application is the U.S. National Phase of PCT Appln. No. PCT/DE2017/100961 filed Nov. 14, 2017, which claims priority to DE 102016123930.5 filed Dec. 9, 2016, the entire disclosures of which are incorporated by reference herein.

### TECHNICAL FIELD

The disclosure concerns a method for determining the state of a torsional vibration damper of a vehicle, with which wear is detected by detecting structure-borne sound waves.

### BACKGROUND

In order to achieve fuel consumption and CO2 emission targets in vehicles, automobile manufacturers are turning to downsizing and downspeeding. In this case, smaller engines with fewer cylinders compensate for the lack of displacement with increased average pressure and are also mainly operated at lower engine revolution rates. However, said increased combustion chamber pressure and lower ignition frequencies because of the reduced engine revolution rates result in strong oscillations in the crankshaft. Therefore, torsional vibration dampers are used to compensate for the rotational disturbances and keep the vibrations of the crankshaft away from the belt drive and from the auxiliary assemblies. On the driven side, such torsional vibration dampers are used between the engine and the gearbox. A failure of such a torsional vibration damper can result in major engine damage in the most serious case. Torsional vibration dampers are subject to increasing wear, inter alia when elastomers are used, which heretofore can only be checked in the dismantled state in a workshop with corresponding costs.

A device for monitoring at least one mechanically highly loaded component in a motor vehicle is known from DE 10 2009 059 136 A1, with which a sensor for detecting structure-borne sound waves and/or transversal sound waves is disposed on said mechanically highly loaded component, which is connected to an analysis unit for analyzing the signals received from the sensor. By means of said device, a chassis suspension, a bearer or a windshield can be monitored for defects, for example.

DE 2004 058 682 A1 discloses a method for monitoring and controlling a combustion engine, by means of which the monitoring of the proper operation and the wear state of a fuel injection system and the combustion engine is possible. With this method it is provided that in diesel combustion engines a structure-borne sound of the combustion engine in the overrun mode is detected and the signal of a structure-borne sound sensor is compared with a limit value, wherein a fault signal is output if the signal of the structure-borne sound sensor is greater than or less than the limit value. The wear measurement by means of structure-borne sound in the overrun mode of the combustion engine is possible if no fuel is injected into the combustion chambers and thus no combustion is taking place in the combustion chambers.

### SUMMARY

It is the object of the disclosure to specify a method for determining the state of a torsional vibration damper of a vehicle, with which the wear of the torsional vibration damper can be concluded inexpensively and rapidly.

The object is achieved by analyzing the structure-borne sound waves using an image of the structure-borne sound acquired during the driving operation of the vehicle according to the operating point. During this, the property of the torsional vibration damper in which different wear effects of the torsional vibration damper cause different fault images at different operating points of the vehicle is exploited. Thus, faults in the torsional vibration damper can be reliably distinguished while the vehicle is travelling using the image of the structure-borne sound.

For determining the state of the torsional vibration damper the image of the structure-borne sound of a sensor positioned at a distance from the torsional vibration damper is advantageously analyzed. This has the advantage that an adequate analysis is always enabled if the corresponding sensor is not directly attached to the torsional vibration damper, but only has a working connection thereto. This allows the arrangement of the sensor depending on the installation space, whereby sensor installation space on the torsional vibration damper itself is not necessary.

In one design, the image of the structure-borne sound of an acoustic sensor that is present in the vehicle is analyzed. Because it is usual to dispose acoustic sensors in the vicinity of a combustion engine for analyzing a number of signals, the state of the torsional vibration damper can be reliably concluded using the analysis of the image of the structure-borne sound of such an existing acoustic sensor.

In one version, a knock sensor that is disposed on the gasoline engine is used as a sensor that is present in the vehicle. Such a knock sensor not only provides signals relating to the ignition behavior of the gasoline engine itself, but also at the same time indications of the state of the torsional vibration damper, which is disposed for example between a belt drive and the gasoline engine or the gasoline engine and the gearbox, for the different operating points of the vehicle.

In an alternative, an injection amount determining sensor of a diesel engine is used as a sensor that is present in the vehicle. The image of the structure-borne sound of such an injection amount determining sensor can also be are analyzed as to whether there is wear on the torsional vibration damper.

In one development, a method of analyzing the image of the structure-borne sound is selected depending on the operating point of the vehicle. This procedure enables the respective classified fault to be recognized particularly easily by a suitable analysis method.

In one embodiment, an amplitude of a sensor signal of the sensor for a specified frequency is analyzed as the analysis method. By means of said analysis method, a certain fault image of the torsional vibration damper can be particularly easily detected.

In an alternative, a frequency modulation analysis or a sideband analysis is used as the analysis method. Said analysis methods enable definite identification of further fault images of the torsional vibration damper.

Advantageously, a wear state of the torsional vibration damper is concluded if a parameter to be analyzed exceeds a parameter threshold. As a result, natural fluctuations of the parameter remain unconsidered in the fault analysis, so that effectively a corresponding fault and thus existing wear of the torsional vibration damper is only concluded in the case of true deviations from the threshold value.

In one alternative, the parameter threshold is continuously adjusted from a moving average. This enables an adaptive detection threshold for fault detection.

In a further embodiment, an analysis method for determining the state of the torsional vibration damper is integrated within an existing engine sensing arrangement analysis method. The described analysis method thus has the advantage that it does not require dedicated sensors, but that an image of the structure-borne sound provided by the corresponding sensor is analyzed by an additional analysis method. In this case, said additional analysis method is a component of the existing analysis method of the engine sensing arrangement, which is a particularly inexpensive procedure.

### BRIEF DESCRIPTION OF THE DRAWINGS

The disclosure enables numerous embodiments. One of these will be described in detail using the figures represented in the drawing.

In the figures:

FIG. 1 shows a first exemplary embodiment of the method,

FIG. 2 shows a second exemplary embodiment of the method.

### DETAILED DESCRIPTION

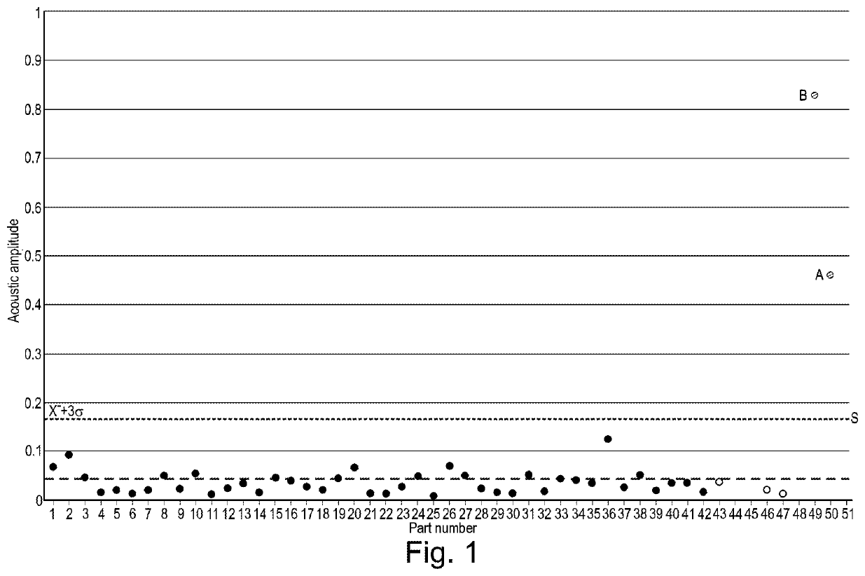

In FIG. 1 a first exemplary embodiment of the method is represented, with which inadequate functionality of a torsional vibration damper is detected using acoustic detection of structure-borne sound. During this, an acoustic image of the structure-borne sound that is output by the structure-borne sound sensor that is attached to the engine is analyzed, with which an acoustic amplitude is represented by means of a number of different measurements. For an amplitude of 0.2 a standard deviation of the acoustic amplitude is indicated as the threshold value S. The measurement results that lie below said standard deviation indicate that the measured component is in order. The components with acoustic amplitudes exceeding said threshold value S, which forms the standard deviation, stand out from the tolerance-related focus. Thus, a measurement point A at about 0.46 of the acoustic amplitude has been determined, whereas a second measurement point B at 0.82 of the acoustic amplitude has been detected. The measurement result A is a torn rubber in the path of the torsional vibration damper, whereas the measurement result B indicates that a roller is missing in the torsional vibration damper.

Such an analysis is possible because certain defects of the torsional vibration damper occur at different operating points of the vehicle. Thus, while the vehicle is travelling corresponding faults can be identified from the image of the structure-borne sound from the knock sensor. An analysis can in particular identify whether a stop buffer or a rubber of the torsional vibration damper is defective at low engine revolution rates, advantageously when idling. The rubbers can have become brittle or can have completely failed here. In the case of the partially loaded vehicle, for example when starting, where a rise in the revolution rate occurs, it can be particularly simply detected from the image of the structure-borne sound whether a roller of the torsional vibration damper is missing. A jamming material, as represented in FIG. 1, can be particularly advantageously determined when the vehicle is under full load.

The corresponding analysis method is also selected depending on the operating point of the vehicle. Thus for example, as already described the amplitude can be analyzed for defined frequencies. At other operating points, analysis methods such as frequency modulation, the envelope of the frequency or a sideband analysis are to be used. The analysis methods are not limited only to the method mentioned in this section in this case.

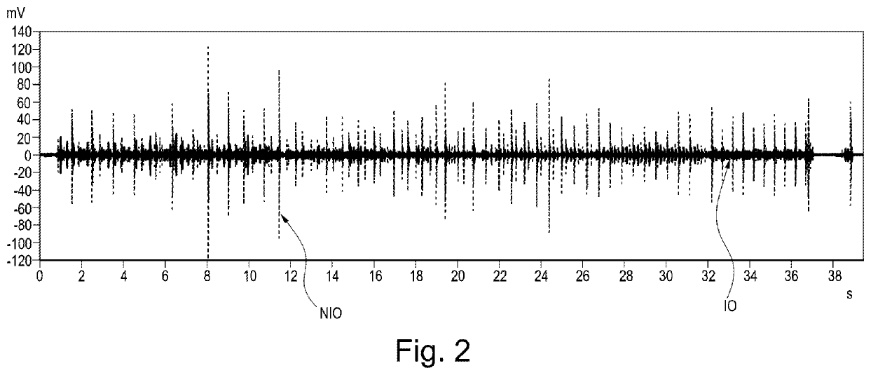

In FIG. 2, an analysis method is illustrated, with which an output signal of the structure-borne sound sensor is represented against time. The graph IO shows only slight fluctuations in this case, for which reason proper operation of the component is concluded. The graph NIO shows a defective component because of a missing stop element, in particular because level peaks occur with a certain periodicity. Said level peaks represent a large rotary oscillation amplitude and are caused by a defective torsional vibration damper.

With the present solution, a wear state of a torsional vibration damper can be analyzed by means of an acoustic sensor. During this, fault images of the torsional vibration damper are determined for specified operating points of the vehicle, wherein at least one specified analysis method is used for each fault recognition. The fault monitoring can be carried out easily while the vehicle is being driven and replaces a visual check in the workshop. Thus, this results in very rapid and inexpensive identification of any signs of wear in the torsional vibration damper.

1. A method for determining the state of a torsional vibration damper of a vehicle, with which a state is detected by detecting structure-borne sound waves, wherein the structure-borne sound waves are analyzed according to the operating point using an image of the structure-borne sound that is acquired while the vehicle is being driven.

2. The method of claim 1, wherein for determining the state of the torsional vibration damper the image of the structure-borne sound of a sensor positioned at a distance from the torsional vibration damper is analyzed.

3. The method of claim 2, wherein the image of the structure-borne sound of an acoustic sensor that is present in the vehicle is analyzed.

4. The method of claim 3, wherein a knock sensor that is disposed on a gasoline engine is used as a sensor that is present in the vehicle.

5. The method of claim 3, wherein an injection amount determining sensor of a diesel engine is used as a sensor that is present in the vehicle.

6. The method of claim 1, wherein a method of analyzing the image of the structure-borne sound is determined depending on the operating point of the vehicle.

7. The method of claim 6, wherein as the analysis method an amplitude of a sensor signal of the sensor is analyzed at a specified frequency.

8. The method of claim 6, wherein a frequency modulation analysis or a sideband analysis is used as the analysis method.

9. The method of claim 1, wherein a wear state of the torsional vibration damper is concluded if a parameter to be analyzed exceeds a parameter threshold value.

10. The method of claim 1, wherein an analysis method for determining the state of the torsional vibration damper is integrated within an existing engine sensing arrangement analysis method.

11. A method for determining the state of a torsional vibration damper of a vehicle, the method comprising:
using a sensor to detect knock of a gasoline powered engine;
while the vehicle is being driven at a predetermined operating point, detecting structure-borne sound waves using the sensor;
analyzing an image of the structure-borne sound to diagnose a failure state of the torsional vibration damper.

12. The method of claim 11, wherein analyzing an image of the structure born sound comprises analyzing an amplitude of a sensor signal at a specified frequency.

13. The method of claim 11, wherein analyzing an image of the structure born sound comprises performing a frequency modulation analysis.

14. The method of claim 11, wherein analyzing an image of the structure born sound comprises performing a sideband analysis.

15. The method of claim 11, wherein the failure state of the torsional vibration damper is a torn rubber.

16. The method of claim 11, wherein the failure state of the torsional vibration damper is a missing roller.

17. The method of claim 11, wherein the failure state of the torsional vibration damper is a jamming material.

18. A method for determining the state of a torsional vibration damper of a vehicle, the method comprising:
using a sensor to an injection amount of a diesel engine;
while the vehicle is being driven at a predetermined operating point, detecting structure-borne sound waves using the sensor;
analyzing an image of the structure-borne sound to diagnose a failure state of the torsional vibration damper.

19. The method of claim 11, wherein the failure state of the torsional vibration damper is a torn rubber.

20. The method of claim 11, wherein the failure state of the torsional vibration damper is a missing roller.
